(19) United States
(12) Patent Application Publication
(10) Pub. No.: US 2023/0401541 A1
(43) Pub. Date: Dec. 14, 2023

(54) INTELLIGENT TASK SCHEDULING

(71) Applicant: SAGE Technology Partners, Inc., Atlanta, GA (US)

(72) Inventor: Abdoul-Aziz Housseini, Atlanta, GA (US)

(21) Appl. No.: 17/836,725

(22) Filed: Jun. 9, 2022

(51) Int. Cl. G06Q 10/10; G06Q 10/06; G06N 5/02

(52) U.S. Cl. CPC G06Q 10/1097; G06Q 10/06314; G06Q 10/06316; G06N 5/022

(57) ABSTRACT

A system can include a computing device and a data store including a training data set with historical data for completed deliverables. The computing device can train a machine-learning model to generate predictive outcomes based on the training data set. The computing device can determine input variables associated with the machine-learning model and identify a deliverable corresponding to a particular program. The computing device can determine a subset of resources from a plurality of resources. The computing device can determine a predicted completion date for the deliverable by processing the metadata associated with the deliverable and performance data corresponding to the subset of resources assigned to the deliverable. The computing device can perform a comparison of the predicted completion date of the deliverable to an expected completion date of the deliverable.

### TECHNICAL FIELD

The present systems and processes generally relate to task scheduling and program management.

### BACKGROUND

Previous approaches to program management may fail to leverage all of the intelligence from historical successful, unsuccessful, and delayed programs. Such approaches are commonly human-centric and rely on anecdotal experience to identify program delays and optimize resources for completing program tasks and deliverables and for meeting program objectives. Human-centric processes for leveraging historical experiences are limited as it is impractical for human minds to process large volumes of data to identify problems extracted from volumes of data and apply solutions to those problems in real time thereby improving system performance. Moreover, reliance on anecdotal experience may cause previous approaches to underestimate program delays, misidentify sources thereof, and incorrectly structure program resources, thereby precipitating further program delays and improvidence in resource allocation. Therefore, there exists a long-felt, but unmet need for improved systems and processes for predicting program outcomes and optimizing program resources.

### BRIEF SUMMARY OF THE DISCLOSURE

Briefly described, and according to one embodiment, aspects of the present disclosure generally relate to systems and processes for generating and training machine-learning models to predict program completion and resource utilization.

In various embodiments, the present systems and processes can generate predicted times and costs for completing programs, or elements thereof, such as deliverables, tasks, and milestones. The present systems and processes can retrieve and receive historical data corresponding to the completion of historical deliverables, tasks, and milestones. The historical data can include metadata and performance data associated with the historical deliverable and with resources used to complete the historical deliverable. The system can perform various techniques to identify historical data that may be similar or relevant to completion of a current deliverable (e.g., natural language processing (NLP), including vectorization and clustering, keyword and key phrase identification, topic modeling, mutual information classification, trained neural networks and other machine-learning models, etc.). The system can generate training sets based on the historical data. The system can use the training sets to train machine-learning models for generating predictions, such as predicted completion dates for a deliverable, predicted cost of resources for completing a deliverable, and minimum completion date for completing a deliverable at minimum or maximum cost.

The system can execute trained machine-learning models on program data and resource data associated with a deliverable to be completed. The system, via trained machine-learning model can process the program data and resource data to generate a completion date prediction. The system can compare the completion date prediction to an expected completion date of the deliverable. Based on the comparison and the trained machine-learning mode, the system can identify one or more modifications to the program data or resource data. The system can identify the modification based on a predetermined objective, such as reducing the completion date prediction and/or reducing a cost of completing the deliverable by the expected completion date, the completion date prediction, or a date therebetween. The system can determine, for example, that a change of resource supplier, to resource delivery date, or to resource ordering date may reduce the completion date prediction. The system can determine, for example, that parallel or semi-parallel (e.g., versus serialized) performance of deliverable-associated tasks may reduce time and/or cost required to complete the deliverable. The system can generate a recommendation including the prediction and the modification. The system can transmit the recommendation to a computing device associated with an owner, operator, or other responsible entity of the deliverable.

According to a first aspect, a system, including: A) a data store including a training data set including historical data for a plurality of completed deliverables; and B) at least one computing device in communication with the data store, the at least one computing device configured to: 1) train at least one machine-learning model to generate predictive outcomes based on the training data set; 2) determine a plurality of input variables associated with the at least one machine-learning model; 3) identify a deliverable corresponding to a particular program, the deliverable including a plurality of tasks and metadata associated with the deliverable; 4) determine a subset of resources from a plurality of resources, wherein the subset of resources are assigned to the deliverable; 5) determine a predicted completion date for the deliverable by processing, via the at least one machine-learning model, the metadata associated with the deliverable and performance data corresponding to the subset of resources assigned to the deliverable; 6) perform a comparison of the predicted completion date of the deliverable to an expected completion date of the deliverable; and 7) generate a recommended modification to the subset of resources assigned to the deliverable based on the comparison.

According to a further aspect, the system of the first aspect or any other aspect, wherein the at least one computing device configured to: A) determine a selected resource for modification from the subset of resources; B) determine an estimated completion date for the deliverable using the selected resource; C) determine an actual completion date for the deliverable; and D) tune the at least one machine-learning model based on the estimated completion date and the actual completion date.

According to a further aspect, the system of the first aspect or any other aspect, wherein the at least one computing device configured to determine a plurality of costs individually associated with a corresponding one of the subset of resources, wherein the recommended modification is generated based in part on the plurality of costs.

According to a further aspect, the system of the first aspect or any other aspect, wherein the performance data further includes a plurality of respective data metrics for each of the subset of resources.

According to a further aspect, the system of the first aspect or any other aspect, wherein the plurality of respective data metrics includes a current workload metric and a historical performance metric.

According to a further aspect, the system of the first aspect or any other aspect, wherein the historical performance metric includes a plurality of expected completion times and a corresponding plurality of actual completion times for past deliverables.

According to a further aspect, the system of the first aspect or any other aspect, wherein generating the recommended modification includes the at least one computing device being further configured to: A) identify at least one replacement resource from the plurality of resources; B) generate a modified subset of resources by modifying the subset of resources based on the at least one replacement resource; C) determine a modified predicted completion date based on the modified subset of resources via the at least one machine-learning model; and D) generate the recommended modification to assign the modified subset of resources for the deliverable based on a second comparison of the modified predicted completion date to the predicted completion date.

According to a further aspect, the system of the first aspect or any other aspect, wherein the at least one computing device is configured to: A) generate a user interface including the recommended modification; and B) cause a second computing device to render the user interface.

According to a further aspect, the system of the first aspect or any other aspect, wherein the user interface further includes the comparison of the predicted completion date of the deliverable to the expected completion date of the deliverable.

According to a further aspect, the system of the first aspect or any other aspect, wherein the at least one machine-learning model includes a multilayer neural network.

According to a further aspect, the system of the first aspect or any other aspect, wherein training the at least one machine-learning model includes adjusting at least one parameter of the multilayer neural network, wherein the at least one parameter includes an activation function, one or more initial weight values, a number of hidden layers, or a number of activation units in at least one hidden layer of the multilayer neural network.

According to a second aspect, a method, including: A) training, via at least one computing device, at least one machine-learning model to generate predictive outcomes based on a training data set including historical data for a plurality of completed deliverables; B) determining, via the at least one computing device, a plurality of input variables associated with the at least one machine-learning model; C) identifying, via the at least one computing device, a deliverable corresponding to a particular program, the deliverable including a plurality of tasks and metadata associated with the deliverable; D) determining, via the at least one computing device, a subset of resources from a plurality of resources, wherein the subset of resources are assigned to the deliverable; E) determining, via the at least one computing device, a predicted completion date for the deliverable by processing, via the at least one machine-learning model, the metadata associated with the deliverable and performance data corresponding to the subset of resources assigned to the deliverable; F) performing, via the at least one computing device, a comparison of the predicted completion date of the deliverable to an expected completion date of the deliverable; and G) generating, via the at least one computing device, a recommended modification to the subset of resources assigned to the deliverable based on the comparison.

According to a further aspect, the method of the second aspect or any other aspect, further including: A) applying, via the at least one computing device, a natural language model to a plurality of particular tasks unrelated to the deliverable to determine a plurality of vectors individually corresponding to one of the plurality of particular tasks; and B) determining, via the at least one computing device, a subset of related tasks of the plurality of particular tasks based on a subset of the plurality of vectors meeting a predefined threshold.

According to a further aspect, the method of the second aspect or any other aspect, wherein the historical data includes a plurality of historical resources used to complete each of the plurality of completed deliverables.

According to a further aspect, the method of the second aspect or any other aspect, wherein the historical data includes a cost of each of the plurality of historical resources.

According to a further aspect, the method of the second aspect or any other aspect, wherein the historical data includes, for each of the plurality of completed deliverables, an actual completion date and at least one expected completion date.

According to a third aspect, a non-transitory computer-readable medium embodying a program that, when executed by at least one computing device, causes the at least one computing device to: A) train at least one machine-learning model to generate predictive outcomes based on a training data set including historical data for a plurality of completed deliverables; B) determine a plurality of input variables associated with the at least one machine-learning model; C) identify a deliverable corresponding to a particular program, the deliverable including a plurality of tasks and metadata associated with the deliverable; D) determine a subset of resources from a plurality of resources, wherein the subset of resources are assigned to the deliverable; E) determine a predicted completion date for the deliverable by processing, via the at least one machine-learning model, the metadata associated with the deliverable and performance data corresponding to the subset of resources assigned to the deliverable; F) perform a comparison of the predicted completion date of the deliverable to an expected completion date of the deliverable; and G) generate a recommended modification to the subset of resources assigned to the deliverable based on the comparison.

According to a further aspect, the non-transitory computer-readable medium of the third aspect or any other aspect, wherein the program, when executed by the at least one computing device, causes the at least one computing device to: A) determine a first cost of completing the deliverable by the predicted completion date using the subset of resources; B) generate a modified subset of resources based on the subset of resources and the recommended modification; C) determine a second cost of completing deliverable by the predicted completion date using the modified subset of resources; and D) adjust the recommended modification to the subset of resources based on a second comparison of the first cost to the second cost.

According to a further aspect, the non-transitory computer-readable medium of the third aspect or any other aspect, wherein the program, when executed by the at least one computing device, causes the at least one computing device to: A) determine that a current date is within a predetermined range of the expected completion date; and B) in response, determine the predicted completion date for the deliverable.

According to a further aspect, the non-transitory computer-readable medium of the third aspect or any other aspect, wherein the at least one machine-learning model is configured to determine the predicted completion date for the deliverable based on a maximum allowable cost associated with the subset of resources.

These and other aspects, features, and benefits of the claimed embodiment(s) will become apparent from the following detailed written description of the various embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment.

FIG. 1 shows an exemplary prediction workflow according to one embodiment of the present disclosure.

FIG. 2 shows an exemplary network environment in which the present prediction system may operate according to one embodiment of the present disclosure.

FIG. 3 shows an exemplary prediction process according to one embodiment of the present disclosure.

FIG. 4 shows an exemplary training process according to one embodiment of the present disclosure.

FIG. 5 shows an exemplary prediction process according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to task scheduling and program management.

### Exemplary Embodiments

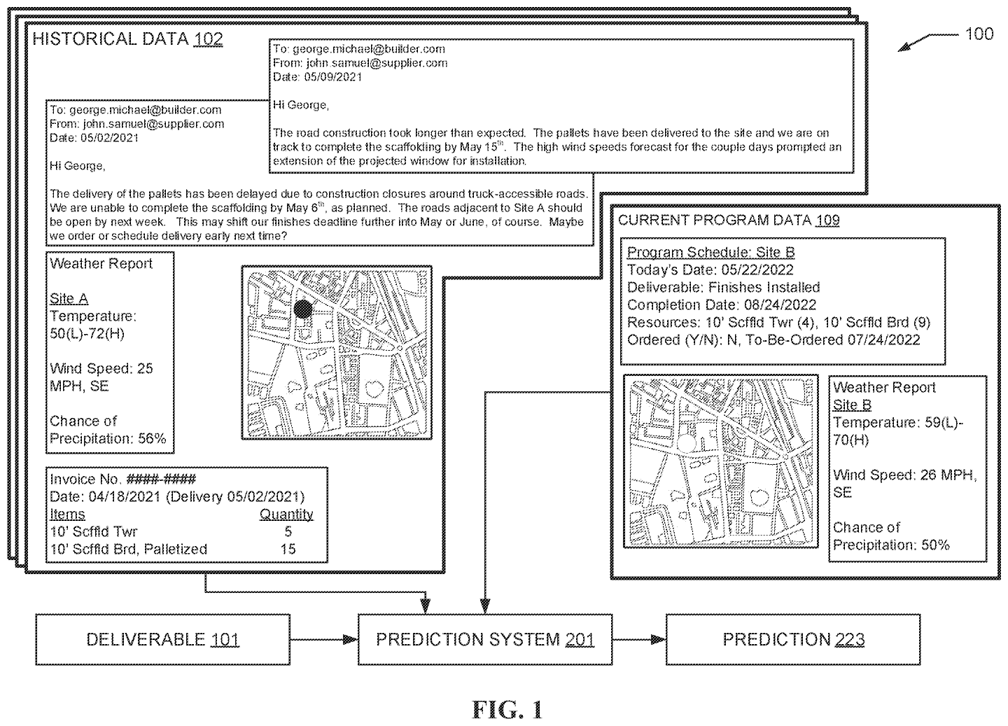

Referring now to the figures, for the purposes of example and explanation of the fundamental processes and components of the disclosed systems and processes, reference is made to FIG. 1, which illustrates an exemplary prediction workflow 100. As will be understood and appreciated, the exemplary prediction workflow 100 shown in FIG. 1 represents merely one approach or embodiment of the present system, and other aspects are used according to various embodiments of the present system.

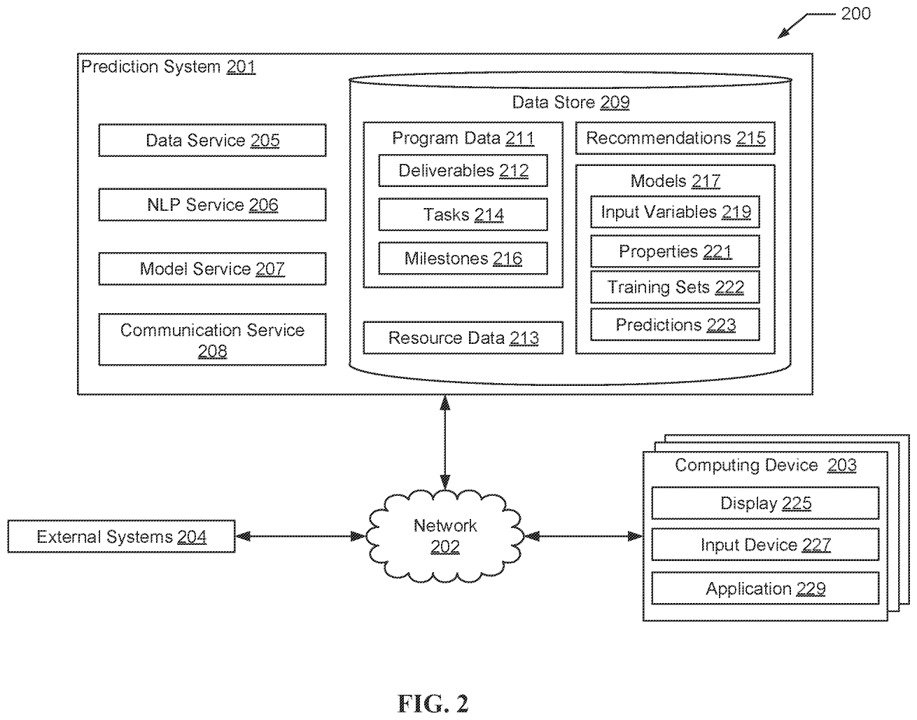

FIG. 1 includes an exemplary prediction system 201 further shown in FIG. 2 and described herein. In various embodiments, the prediction system 201 analyzes historical program data and current program data to generate predictions for completing program deliverables, tasks, and milestones. As shown, the prediction system 201 can receive and analyze historical data 102 that includes historical deliverables, tasks, and/or milestones, and includes resources associated with completing the historical deliverables, tasks, and/or milestones. In some embodiments, the historical data 102 includes metadata and performance associated with completing the deliverables, such as, for example, costs of resources (e.g., invoices and other accounting records), resource supplier or vendor, expected and actual delivery dates of resources, location of the deliverable, and electronic communications associated with the deliverable. The historical data 102 can be associated with a plurality of historical programs. According to one embodiment, historical data 102 corresponds to historical program data 211 and historical resource data 213 (e.g., shown in FIG. 2 and described herein).

The prediction system 201 can receive or retrieve a deliverable 101, such as, for example, completing finishes on a building. The deliverable 101 can be associated with a plurality of tasks and resources. Non-limiting examples of tasks include ordering supplies, receiving delivery of supplies, obtaining permits constructing scaffolding, installing finishes. Non-limiting examples of resources include scaffolds, scaffold boards, fasteners, and human capital. The prediction system 201 can identify the historical data 102 based on the deliverable 101. The prediction system 201 can retrieve or receive current program data 109 associated with the deliverable 101. The current program data 109 can include, for example, a schedule for completing the deliverable 101, a location of the deliverable 101, a weather report associated with the location, an expected completion date of the deliverable 101, a current date, resources associated with completing the deliverable 101, indications of whether the resources have been ordered, and indications of when the resources are to be ordered.

The prediction system 201 can analyze a plurality of historical electronic correspondences (e.g., email chains and messaging platform conversations) to identify subsets thereof that may be associated with the deliverable 101 (e.g., due to their being associated with a historical deliverable similar to the deliverable 101, or a factor thereof, such as location, weather, requisite resources, resource vendors, human capital, etc.). The prediction system 201 can perform natural language processing (NLP) on the deliverable 101 (e.g., program and resource data associated therewith) and the historical data 102 to vectorize, cluster, and compare the deliverable 101 and the historical data 102. Based on distance comparisons in the vector and cluster domain, the prediction system 201 can determine associations between subsets of the historical data 102, thereby indicating that the subset of historical data 102 associated therewith may be used to train a model to generate predictions associated with the deliverable 101.

The prediction system 201 can identify subsets of the historical data 102 based on additional factors, such as, for example, a) association of the historical data 102 to a location within a predetermined range of the location of the deliverable 101, b) association of the historical data 102 with similar weather conditions predicted for the deliverable 101, and c) association with similar resources to resources to be used for completing the deliverable 101.

As further described herein and shown in the accompanying figures, the prediction system 201 can generate and train machine-learning models to generate various predictions 223. The prediction 223 can include, for example, a predicted completion date of the deliverable 101, a predicted cost of completing the deliverable 101, a predicted lead time for ordering resources for completing the deliverable 101, and other suitable predictions that will become apparent to one of ordinary skill in response to the present disclosure.

In an exemplary scenario, the prediction system 201 can receive a deliverable 101 for completing finish installation at a Site B. The prediction system 201 receives current program data 109 including a current date, the deliverable 101, the location of Site B, a weather forecast for Site B, an expected completion date, resources for installing the finishes, indication of whether the resources have been ordered, and a scheduled ordering date for placing the order(s) for the resources. Based on the current program data 109 and the deliverable 101, the prediction system 201 identifies historic data 102 that may be used to train a machine-learning model to generate predictions 223 for the deliverable 101. FIG. 1 shows an exemplary entry of historical data 102. It will be understood and appreciated that the prediction system 201 can identify and analyzes tens to thousands to millions of historical data points and entries for training machine-learning models discussed herein. The historical data 102 shown in FIG. 1 is provided for illustrating and describing exemplary aspects of the prediction system 201 and no limitation is intended thereby. The following scenario is presented in the context of determinations generated by the prediction system 201 from processing and analyzing historical data 102. The determinations may be representative of a plurality of determinations from obtained from various instances of linked and unlinked historical data points and entries.

Based on keyword detection and/or NLP processing and comparison, the prediction system 201 identifies email conversations for a historical deliverable of completing finishes. The prediction system 201 further determines the deliverable is associated with a Site A location. Based on timestamps of the email conversations and the identification of the Site A location, the prediction system 201 retrieves a weather report associated with the Site A location. Further, based on keywords of the email conversations, the prediction system 201 identifies historical resources used to complete the historical deliverable and retrieves an invoice associated with purchase of the historical resources.

The prediction system 201 can determine that the historical deliverable is associated with delay events including a road closure adjacent to Site A and a high winds condition at Site A. The prediction system 201 can generate a time series of data points associated with the historical deliverable, such as that an order for resources was placed on Apr. 18, 2021, expected delivery of the resources was on May 2, 2021, a first delay event alert was communicated on May 2, 2021 (e.g., road closure), a second delay alert was communicated on May 9, 2021 (e.g., high winds), a predicted completion date for the historical deliverable on May 6, 2021, and a predicted completion date for the historical deliverable on May 15, 2021. The prediction system 201 can compare the historical data 102 to the current program data 109 and identify comparable conditions of the current program data that may precipitate delays to completing the deliverable 101. The prediction system 201 can train a machine-learning model on a dataset including the historical data 102. The prediction system 201 can train the machine-learning model to predict a completion date for the historical deliverable based on the historical data 102. The prediction system 201 can further determine, from the machine-learning model, one or more subsets or entries of the historical data 102 that most contributed to a predicted completion date occurring past an expected completion date of the historical deliverable. The prediction system 201 can executed one or more trained machine-learning models on the current program data 109 associated with the deliverable 101 and, thereby, generate a prediction 223 for the deliverable 101, such as a predicted completion date and one or more elements of the current program data 109 that most contribute to the predicted completion date.

The prediction system 201 can determine, via one or more trained machine-learning models, that a) the Site B location is within a predetermined range of the Site A location, and b) the time period during which the deliverable 101 is to be completed overlaps with a historical period during which road closures are imposed adjacent to Sites A and B. In response, the prediction system 201 determines a high likelihood of a delay event for the deliverable 101. The prediction system 201 further determines that a wind speed associated with the Site B weather report is similar to the historical wind speed associated with a delay event of the historical deliverable. In response, the prediction system 201 determines a high likelihood of a second delay event for the deliverable 101. Based on the estimated high likelihood of first and second delay events for the deliverable 101, the prediction system 201 generates a first prediction 223 including a predicted completion date for the deliverable 101 past its current expected completion date. Further, the prediction system 201 generates a recommended modification to the resources associated with completing the deliverable 101. The recommended modification can include a suggested date for ordering and receiving delivery of the resources prior to the historical period during which the road closures are imposed adjacent to Sites A and B. The prediction system 201 can generate a second prediction 223 based around a scenario in which the recommended modification is performed. The second prediction 223 may be closer in time to the expected completion date, thereby indicating a delay to completing the deliverable 101 may be mitigated or reduced by performing the recommended modification.

FIG. 2 shows an exemplary networked environment 200 in which an exemplary prediction system 201 may operate. The networked environment 200 can include, but is not limited to, the prediction system 201, one or more computing devices 203, and one or more external systems 204. The prediction system 201 can communicate with the computing device 203 and the external system 204 via one or more networks 202. The network 202 includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks.

The prediction system 201 can include, but is not limited to, a data service 205, a natural language processing (NLP) service 206, a model service 207, a communication service 208, and one or more data stores 209. The prediction system 201 includes, for example, a Software as a Service (SaaS) system, a server computer, or any other system providing computing capability. Alternatively, the prediction system 201 may employ computing devices that may be arranged, for example, in one or more server banks or computer banks or other arrangements. Such computing devices can be located in a single installation or may be distributed among many different geographical locations. For example, the prediction system 201 can include computing devices that together may include a hosted computing resource, a grid computing resource, and/or any other distributed computing arrangement. In some cases, the prediction system 201 can correspond to an elastic computing resource where the allotted capacity of processing, network, storage, or other computing-related resources may vary over time. Various applications and/or other functionality may be executed in the prediction system 201 according to various embodiments. In some embodiments, the NLP service 206 is an external system that can communicate with the prediction system 201.

Various data is stored in the data store 209 that is accessible to the prediction system 201. In some embodiments, the data store 209, or a subset of data stored thereat, is accessible to the computing device 203. The data store 209 can be representative of a plurality of data stores 209 as can be appreciated. The data stored in the data store 209, for example, is associated with the operation of the various applications and/or functional entities described below. The data store 209 can include, but is not limited to, program data 211, resource data 213, recommendations 215, and models 217. The data store 209 can information in a time series format such that the stored information preserves a historical linearity associated therewith.

The program data 211 can include, but is not limited to, deliverables 212, tasks 214, and milestones 216. The program data 211 can include various metadata, such as, for example, timestamps, locations, and entities with which program data is associated. The metadata of the program data 211 can include program labels for indicating particular programs with which subsets of the program data 211 are associated. In one example, the program data 211 includes deliverables 212, tasks 214, and milestones 216 that are associated with a mixed-use development project “Peachtree Square” located at 1295 Peachtree Ln, Atlanta, GA, under development from Sep. 1, 2016-May 13, 2018, and developed by Palmer Partners LLC. In this example, each of the deliverables 212, tasks 214, and milestones 216 include metadata for indicating association with the Peachtree Square project, with the location 1295 Peachtree Ln, Atlanta, GA, with the timeframe of Sep. 1, 2016-May 13, 2018, and with the entity Palmer Partners LLC.

Non-limiting examples of deliverables 212 include site inspection reports, rough order of magnitude estimates, original and updated acquisition fund balances, Capped Contingent Liquidity Facility (CCLF) acquisition recommendations, original, revised and executed purchase and sale agreements (PSAs), original, revised, and executed letters of intent (LOIs), general liability insurance policies, title insurance records, master drawing request sets, master lien request sets, master change order logs, master substitute logs, building plans, building specifications, digital and physical operations manuals, program accounting records (e.g., for construction, design, acquisition, procurement, development, vendors, labor, materials, etc.), schematic design sets, design development sets, contract document sets, building permits, building permit applications, finishes selection sheets, guaranteed maximum price (GMP) contracts, closing checklists, property photo libraries (e.g., at varying stages of pre-, mid-, and post-development), public relations (PR) plans, groundbreaking plans, escrow settlement statements, drawing packages, property listings, program accounting records, project proposals, commitment letters, underwriting models, underwriting agreements, credit statements and memos, developer requests for proposals (RFPs), developer proposals, evaluation rubrics, and communication records (e.g., for developer, vendor, labor, design, and/or legal communications).

Non-limiting examples of tasks 214 include visiting a program site or other associated location, reviewing a property title and/or other documentation, generating a rough order of magnitude (ROM) estimate, obtaining rebuild team consensus approval, obtaining a CCLF property acquisition recommendation, executing a LOI, executing a PSA, assessing a remaining account balance (e.g., acquisition fund balance, procurement fund balance, construction fund balance, etc.). Further non-limiting examples of tasks 214 include generating a program site inspection estimate, conducting a program site inspection, conducting a construction material or other resource inspection and/or inventory, obtaining pre-, mid-, and/or post-construction photographic documentation, establishing a progress meeting protocol, conducting a progress meeting, establishing a program drawing protocol, generating or obtaining program drawings, establishing a change order protocol, processing a change order, generating a short or long lead item checklist and/or schedule, determining and/or implanting site safety signage, determining and/or implementing site marketing signage, developing a site security protocol, scheduling and/or attending meetings, and capturing program photographic documentation, forming a design team, processing input from a design team (e.g., by receiving the input into the prediction system 201). Additional non-limiting examples of tasks 214 include generating construction assumptions for pricing, obtaining estimates for contractor pricing, selecting finishes and/or other physical design elements, performing a review of construction bid drawings, generating initial development designs (e.g., for exterior skin, emotion, sustainability, diversity, equity, etc.), and reviewing and/or validating contractor pricing. Other non-limiting examples of tasks 214 include drafting a PSA, submitting a PSA to private investment counsel (PIC) and/or a seller attorney, obtaining CCLF approval of developer PSA, reviewing acquisition and closing documentation with title company, performing closing checklist items, acquiring a property, reviewing groundbreaking plans with CCLF, engaging workforce partners, and hosting community and other PR events. By further way of example, tasks 214 may include reviewing and/or approving project proposals, drafting credit memos, obtaining staff approval, obtaining credit committee approval, informing applicant(s) of approval, reviewing drawings and/or the drawing process with applicant(s), drafting and/or transmitting solicitations, generating and/or transmitting a property RFP notification, evaluating and/or scoring a proposal, selecting a proposal, communicating with developer candidates, and transmitting notifications of developer selection.

The resource data 213 can include any information associated with resources that may be consumed in advancing or completing a deliverable 212, task 214, or milestone 216. Non-limiting examples of resources include human resources (e.g., skilled, semi-skilled, or unskilled labor), natural resources, construction materials, transportation infrastructure, onsite or site-adjacent infrastructure, utilities, capital, land, and professional, social, or personal relationships. The resource data 213 can include metadata including, but not limited to, resource quantity (e.g., an amount of resources associated with fulfilling a deliverable, task, or milestone), resource cost (e.g., a history of resource expenses, prices, and/or other costs), resource mass, resource volume, source(s) of resources, entities associated with resources (e.g., resource vendors, deliverers, regulators, inspectors, etc.), resource location, resource quality, resource lead time (e.g., a time required to procure and/or prepare a resource), resource expiration or stale time (e.g., a period after which a resource degrades in quality and/or becomes unusable), resource regulations (e.g., reporting requirements, control requirements, labor and wage regulations, environmental regulations, location-specific ordinances and other rules, etc.), environmental impact of resources, discounts and benefits associated with resources, historical disputes and legal outcomes associated with resources, and reviews and other resource-related feedback. In one or more embodiments, resource data 213 includes schedules by which resources may be utilized or consumed. In at least one embodiment, the schedule can include times for completing tasks 214 by using particular resources. The prediction processes described herein can identify modifications to resources, including modifications to schedules for tasks 214 or other activities related to utilizing resources.

The recommendations 215 can include, but are not limited to, modifications to deliverables 212, tasks 214, milestones 216, resource data 213, or metadata associated therewith. For example, the recommendation 215 includes a modification to one or more resources associated with a particular deliverable 212. In another example, the recommendation 215 includes a recommended delay to a completion date of a deliverable 212, task 214, or milestone 216. In another example, the recommendation 215 includes a suggestion for replacing one or more resources with one or more replacement resources. The recommendation 215 can include a suggestion to adjust an ordering of tasks 214 for one or more deliverables 212. For example, the recommendation 215 includes a suggestion for concurrently executing one or more tasks 214 associated with a deliverable 212. In another example, the recommendation 215 includes a suggestion for swapping the temporal sequence of one or more tasks 214. In still another example, the recommendation 215 includes a suggestion to eliminate one or more tasks 214. The recommendation 215 can include any suitable format including, but not limited to, text strings, artificially generated natural language, electronic mail templates, digital images, videos, audio files, and combinations thereof. The data store 209 can store historical recommendations 215 and, in some embodiments, outcomes associated with recommendations 215. For example, the data store 209 stores a recommendation 215 for substituting a replacement resource for a particular resource, an indication of whether the substitution occurred, and an actual completion date for a deliverable 212 for which the recommendation 215 was generated. In some embodiments, the model service 207 utilizes historical recommendations 215 and/or outcomes associated therewith as an input to model training processes. For example, the model service 207 generates one or more training sets 222 based on historical recommendations 215, historical predictions 223 contained therein, and actual outcomes associated therewith.

The models 217 can include, but are not limited to, input variables 219, properties 221, training sets 222, and predictions 223. Input variables 219 can include, for example, historical and/or current program data 211, historical and/or current resource data 213, and metadata associated therewith each. The input variables 219 are generally associated with a particular program or deliverable 212 (e.g., the particular program or deliverable 212 having been indicated in a request to the prediction system 201). The properties 221 can include any parameter, hyperparameter, configuration, or setting of the model 217. Non-limiting examples of properties 221 include coefficients or weights of linear and logistic regression models, weights and biases of neural network-type models, cluster centroids in clustering-type models, train-test split ratio, learning rate (e.g. gradient descent), choice of optimization algorithm (e.g., gradient descent, gradient boosting, stochastic gradient descent, Adam optimizer, etc.), choice of activation function in a neural network layer (e.g. Sigmoid, ReLU, Tanh, etc.), choice of cost or loss function, number of hidden layers in a neural network, number of activation units (e.g., artificial neurons) in each layer of a neural network, drop-out rate in a neural network (e.g., dropout probability), number of iterations (epochs) in training a neural network, number of clusters in a clustering task, Kernel or filter size in convolutional layers, pooling size, and batch size.

A training set 222 can include, but is not limited to, historical resource data 213 (e.g., including metadata), and/or historical data and metadata associated with one or more completed deliverables 212, tasks 214, and/or milestones 216. The training set 222 can include data metrics for one or more resources described in resource data 213. Non-limiting examples of data metrics include workload metrics and historical performance metrics. In one example, a historical performance metric includes a plurality of expected completion times and a corresponding plurality of actual completion times for past deliverables. In another example, a workload metric includes a number of labor hours associated with completing historical tasks associated with a particular deliverable. The model service 207 can generate training sets 222 and can segment training sets 222 into additional sets for testing and validating trained models 217.

The predictions 223 can include any output of the models 217. The predictions 223 can include, but are not limited to, predicted completion dates for one or more deliverables 212, tasks 214, or milestones 216, predicted delays to deliverables 212, tasks 214, or milestones 216, modifications to one or more resources for completing deliverables 212, tasks 214, or milestones 216, and predicted costs of utilizing one or more resources for completing a deliverable 212, task 214, or milestone 216. In one example, the model service 207 determines a predicted completion date for a deliverable 212 by processing, via one or more models 217, metadata associated with the deliverable 212 and resource data 213 (e.g., historical performance data) corresponding to one or more resources assigned to the deliverable 212 (e.g., and/or tasks 214 associated with completing the deliverable 212). The predictions 223 can include prediction metadata, such as weight values applied by the model 217 to variables 219 associated with a prediction 223. Additional non-limiting examples of prediction metadata include a location, timestamp, and model configuration associated with the generation of the prediction 223.

The model 217 can include a machine-learning or artificial intelligence model that can be trained to learn underlying patterns of program data 211 and resource data 213. The model service 207 can train the model 217 to recognize relationships between one or more resources and deliverables 212, tasks 214, and milestones 216. The model service 207 can train the model 217 to recognize relationships between combinations of deliverables 212, tasks 214, and milestones 216 (e.g., including relationships between metadata associated therewith). Non-limiting examples of models 217 include neural networks, linear regression, logistic regression, ordinary least squares regression, stepwise regression, multivariate adaptive regression splines, ridge regression, least-angle regression, locally estimated scatterplot smoothing, decision trees, random forest classification, support vector machines, Bayesian algorithms, hierarchical clustering, k-nearest neighbors, K-means, expectation maximization, association rule learning algorithms, learning vector quantization, self-organizing map, locally weighted learning, least absolute shrinkage and selection operator, elastic net, feature selection, computer vision, dimensionality reduction algorithms, and gradient boosting algorithms. Neural networks can include, but are not limited to, uni- or multilayer perceptron, convolutional neural networks, recurrent neural networks, long short-term memory networks, auto-encoders, deep Boltzman machines, deep belief networks, back-propagations, stochastic gradient descents, Hopfield networks, and radial basis function networks. The model 217 can be representative of a plurality of models 217 of varying or similar composition or function.

In one example, a model 217 includes a mutual information classifier trained to predict whether a resource vendor is timely, sometimes delayed, or always delayed. In another example, a model 217 includes a random forest algorithm configured to vote on a most likely predicted completion date for a deliverable 212, an optimal resource for completing the deliverable 212, or an optimal replacement resource for reducing or meeting the predicted completion date for the deliverable 212. In another example, a model 217 includes a multi-layer perceptron trained to classify deliverables 212 according to their location (e.g., particular locations being associated with increased or decreased delays to deliverable completion, increased or decreased resource consumption, or other geo-specific considerations). In another example, a model 217 includes a clustering model for grouping input variables 219 (e.g., tasks 214 and resources for completing a deliverable 212) into classifications of “less likely to delay,” “likely to delay,” and “more likely to delay.”

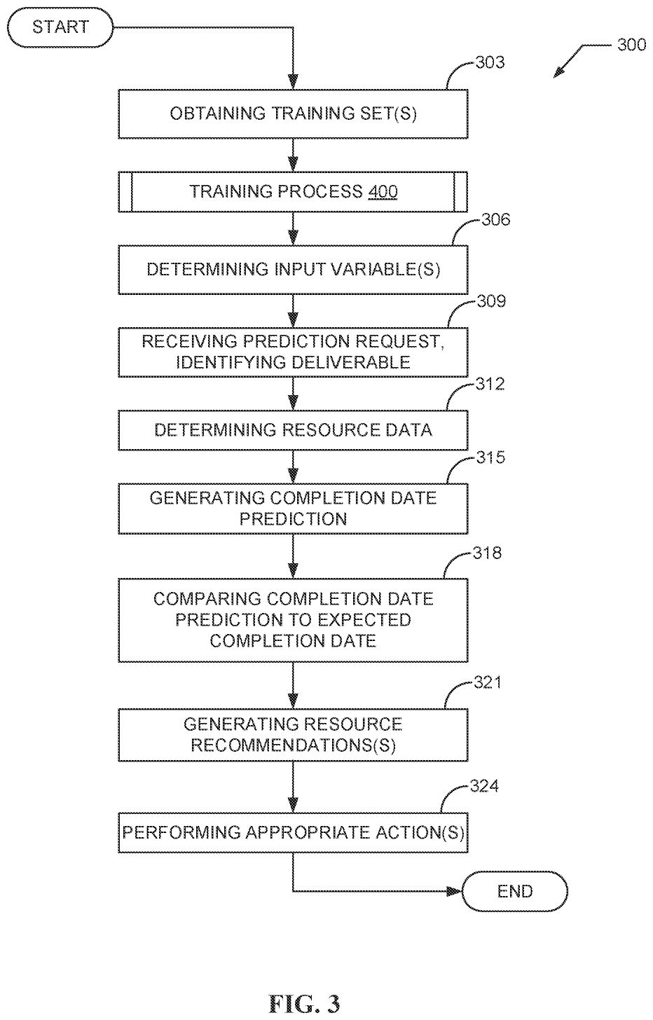

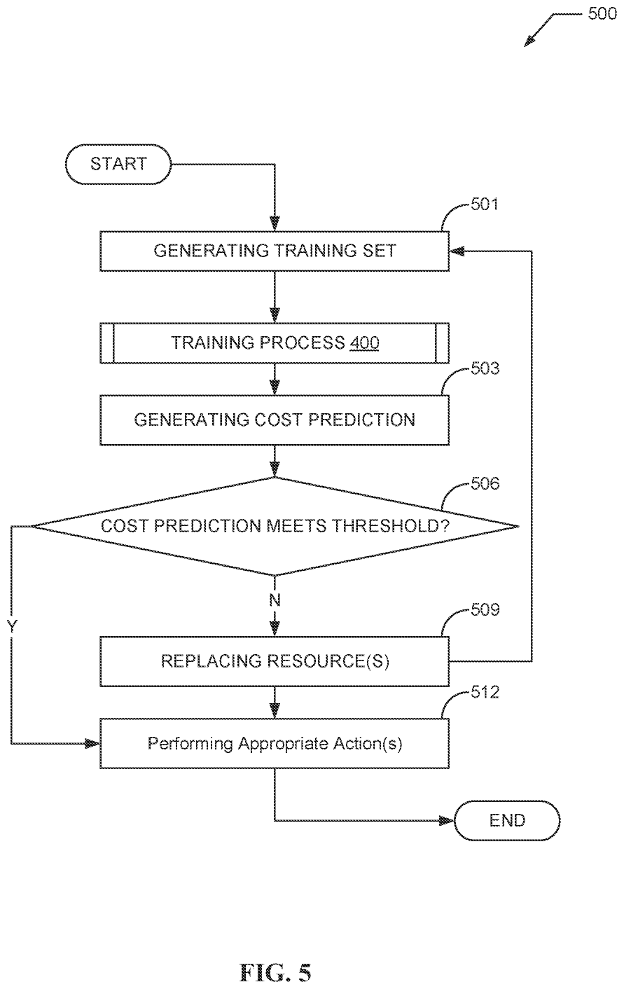

The data service 205 can receive and process requests and various data related to functions of the prediction system 201. The data service 205 can receive requests including, but not limited to, a) requests to generate predicted completion dates deliverables 212, tasks 214, or milestones 216, b) requests to generate recommendations for modifying project resources (e.g., replacing resources, ordering resources by a particular data, ordering resources from a particular supplier, etc.), and c) requests to predict a delay associated with a particular resource, deliverable 212, task 214, or milestone 216 (e.g., or changes thereto). In response to receiving a request, the data service 205 can initiate processes at the prediction system 201, such as, for example, the prediction processes 300 or 500 (e.g., shown in FIGS. 3 and 5, respectively, and described herein). The data service 205 can cause the NLP service 206 to process data, such as electronic communication records. The data service 205 can cause the model service 207 to generate input variables 219 and to generate, train, and execute models 217 for generating predictions 223 based on the input variables 219. The data service 205 can cause the communication service 208 to generate a recommendation 215 based on one or more predictions 223. The data service 205 can cause the communication service 208 to generate and transmit (e.g., or cause the computing device 203 to render) a report, a user interface, an electronic communication, or other suitable means and/or medium for communicating predictions 223 and recommendations 215.

The data service 205 can obtain and process data and metadata from external systems 204 and computing devices 203. For example, the data service 205 can receive data from a computing device 203 via the application 229 and inputs made to an input device 227. In another example, the data service 205 automatically collects or receives data from an external system 204 (e.g., collection occurring at a particular frequency, such as daily, weekly, quarterly, etc., or upon completion of a deliverable 212, task 214, or milestone 216). The data can include, but is not limited to, program data 211, resource data 213, and data from which program data 211 and resource data 213 may be extracted or generated (e.g., electronic records and communications, images, videos, audio files, etc.). In one example, the data service 205 can receive project notes and emails from a remote computing environment associated with storing communications from a plurality of computing devices 203. In another example, the data service 205 can receive electronic accounting and project management records associated with one or more completed projects. In another example, the data service 205 can receive resource costs, lead times, and delivery estimates from a resource supplier system. In another example, the data service 205 can receive, from an online forecasting service, weather information for a particular projection location. In still another example, the data service 205 can receive actual completion times for one or more historical deliverables 212, tasks 214, or milestones 216, and can receive historical resource data 213 associated therewith.

The data service 205 can perform operations to the data including, but not limited to, data filtering (e.g., based on location, time, affiliated entities, project, deliverable, task, or milestone type, etc.), data imputation, outlier removal (e.g., based on statistical analyses of data received), null value removal, optical character recognition (OCR), data enrichment (e.g., associating data with metadata, such as timestamps and locations) and metadata generation. The data service 205 can perform optical character recognition (OCR) processes to detect and extract text data from various sources, such as, for example, photographs, digital scans, slideshow presentations, videos, and handwriting. The data service 205 can generate metadata, such as timestamps, location information, and source-identifying information. The data service 205 can generate, for example, a timestamp associated with the date of receipt, delivery, or completion of historical resources, deliverables 212, tasks 214, or milestones 216. The data service 205 can generate location information for indicating a particular geographic location with which data is associated (e.g., the location of historical resources, deliverables 212, tasks 214, or milestones 216).

The NLP service 206 can analyze historical program data 211, resource data 213, recommendations 215, and/or computing device inputs to support various processes and functions of the prediction system 201. The NLP service 206 can process and analyze electronic records and inputs to generate program data 211 and resource data 213 based on language content contained therein. The NLP service 206 can generate deliverables 212, tasks 214, and milestones 216 based on analyses of electronic records, inputs, and/or metadata associated therewith. Non-limiting examples of electronic records include scans of handwritten documents (e.g., meeting summaries, program notes, etc.), electronic communications (e.g., email conversations, text messages, audio communications, or transcriptions thereof, etc.), program records (e.g., statements of work, work logs, contracts, agreements, invoices, reports, estimates, requests for proposals, proposals, recommendations, policies, protocols, manuals, permits, program assumptions, selection sheets, checklists, advertisements, applications, etc.), and digital media (e.g., site photograph or videos, meeting recordings, etc.).

To generate program data 211, resource data 213, or metadata associated therewith, the NLP service 206 can identify, extract, and classify language content via any suitable algorithm, technique, or combinations thereof. In some embodiments, the NLP service 206 communicates with the model service 207 to process electronic records via one or more models 117, such as, for example, machine-learning or artificial intelligence models. Non-limiting examples of machine-learning and/or artificial intelligence techniques include artificial neural networks, mutual information classification models, random forest or tree models, supervised or unsupervised topic-modeling models, Apriori algorithm-based models, and Markov decision models. In one example, the NLP service 206 receives accounting and project management records for processing. The NLP service 206 can analyze the records via a trained neural network that associates subsets of the records with one or more deliverables 212, tasks 214, and milestones 216. The NLP service 206 can generate historical program data 211 and/or historical resource data 213 by storing the subsets of the records in association with the associated deliverable 212, task 214, and/or milestone 216.

The NLP service 206 can perform binary or fuzzy keyword and key phrase matching. The NLP service 206 can determine that an electronic record includes one or more words or phrases from a predetermined keyword list and/or that are included in one or more language libraries or corpuses. The NLP service 206 can perform approximate or fuzzy keyword and key phrase detection, for example, by applying one or more rules, policies, or heuristics. The NLP service 206 can translate electronic records, or portions thereof, into fixed-size vector representations. The NLP service 206 can compare vector representations of electronic records to determine (mis)matches between languages from which the representations were derived. The NLP service 206 can perform vector comparisons via any suitable technique or similarity metric, including, but not limited to, Euclidean distance, squared Euclidean distance, Hamming distance, Minkowski distance, L² norm metric, cosine metric, Jaccard distance, edit distance, Mahalanobis distance, vector quantization (VQ), Gaussian mixture model (GMM), hidden Markov model (HMM), Kullback-Leibler divergence, mutual information and entropy score, Pearson correlation distance, Spearman correlation distance, or Kendall correlation distance.

In an exemplary scenario, the NLP service 206 translates an email into a vector, the email being associated with a schedule change to a particular deliverable 212. The NLP service 206 generates a similarity score between the vector and one or more reference vectors derived from historical language associated with scheduling the particular deliverable 212. In response to determining the similarity score meets a predetermined threshold, the NLP service 206 associates the email with the historical language. Based on the association between the email and the historical language, the model service 207 generates a prediction 223 for a completion date of the particular deliverable 212 (e.g., the model service 207 leveraging scheduling intelligence from the historical language to generate the prediction).

The model service 207 can generate, train, and execute models to generate predictions 223. The model service 207 can train machine-learning and/or artificial intelligence (AI) models based on one or more training sets 222. The model service 207 can analyze a model 217 and associated prediction(s) 223 to determine a contribution of each input variable 219 to the prediction 223. For example, the model service 207 analyzes a model 217 and a prediction 223 to identify one or more input variables 219 that most positively contributed to the prediction 223 and one or more input variables 219 that most negatively contributed to the prediction 223.

The model service 207 can determine one or more input variables 219 to be used for a particular model 217. The model service 207 can retrieve or generate training sets 222 for a particular model 217. The model service 207 can generate a model 217 for generating predictions 223 associated with a particular program specified in the program data 211 (e.g., and/or specified via user input(s) received by the prediction system 201). The model service 207 can determine a set of current deliverables 212, tasks 214, milestones 216, and/or resource data 213 associated with the particular program. The model service 207 can determine a set of historical deliverables 212, tasks 214, milestones 216, and/or resource data 213 associated with historical programs that are similar to the particular program. In some embodiments, the model service 207 analyzes program data 211 of the particular program to identify historical program data 211 with which the particular program data 211 may be associated. The model service 207 can identify additional current deliverables 212, tasks 214, milestones 216, and/or resource data 213 for use as input variables 219 based on analyses of historical program data 211. The model service 207 can generate input variables 219 based on the set of current deliverables 212, tasks 214, and milestones 216. The model service 207 can generate training sets 222 based on the set of historical deliverables 212, tasks 214, milestones 216, and/or resource data 213.

The model service 207 can identify one or more deliverables 212, tasks 214, and/or milestones 216 corresponding to a particular program. In some embodiments, the program data 211 includes associations between one or more deliverables 212, tasks 214, and/or milestones 216 (e.g., including metadata any metadata associated therewith). For example, for a particular deliverable 212, the program data 211 includes a plurality of tasks 214 and metadata associated with the particular deliverable 212. The model service 207 can determine resource data 213 with which program data 211, or a subset thereof, is associated. In some embodiments, the resource data 213 includes associations between subsets of the resource data 213 and particular deliverables 212, tasks 214, and/or milestones 216. The model service 207 can identify a particular deliverable 212 corresponding to a particular program, and the model service 207 can determine a subset of the resource data 213 corresponding to one or more resources with which the particular deliverable 212 is associated. In one example, for a mixed-use development program, the model service 207 identifies a particular deliverable 212 for electrical fixtures. The model service 207 can determine a set of electrical fixture resources (e.g., suppliers, installers, inspectors, etc.) from the resource data 213 that are assigned to the deliverable 212. The model service 207 can determine the set of electrical fixture resources based on metadata associated with the mixed-use development program, such as, for example, a location of the program, budgetary or other financial constraints of the program, diversity and equity policies associated with the program, or one or more time intervals associated with the program (e.g., contracted deadlines, buffer or other tolerable delay intervals, delivery intervals, installation intervals, inspection intervals, etc.).

The model service 207 can determine a predicted completion date for one or more deliverables 212, tasks 214, and/or milestones 216 by processing associated input variables 219 via at least one model 217. For example, the model service 207 determines a predicted completion date for a deliverable 212 by processing, via a machine-learning model, the metadata associated with the deliverable 212 and performance data corresponding to a subset of resource data 213 associated with the deliverable 212. The model service 207 can determine one or more input variables 219 (e.g., or program data 211 or resource data 213 associated therewith) that most positively or negatively contribute to the predicted completion date.

In an exemplary scenario, the model service 207 generates a prediction 223 based on processing a plurality of input variables via a trained machine-learning model. The model service 207 ranks each input variable 219 based on a respective weight value applied to the input variable 219 by the trained machine-learning model. Based on the ranking, the model service 207 determines at least one input variable 219 that provided the greatest positive contribution to the prediction 223 and at least one input variable 219 that provided the greatest negative contribution to the prediction 223. In other words, the model service 207 can determine and report input variables 219 that may be most predictive for maintaining, increasing, or decreasing a predicted completion date.

The model service 207 can generate and train model 217 to generate predictions 223 based on one or more training data sets 222. The model service 207 can execute trained models 217 on user inputs, program data 211, and/or resource data 213 to generate various predictions 223, such as, for example, a predicted completion date for a deliverable 212, task 214, or milestone 216, costs associated with one or more resources, resource replacement candidates, and modified completion dates for deliverables 212, tasks 214, or milestones 216 (e.g., based on use of replacement resources). Further non-limiting examples of predictions 223 include resources that may be required to complete a deliverable 212, task 214, and/or milestone 216 by a particular completion date, recommendations for changes to resources for a particular deliverable 212, task 214, and/or milestone 216, and factors that most positively or negatively contribute to a prediction 223 (e.g., model inputs associated with high positive or negative contributions to the output of the model 217).

The model service 207 can train the model 217 to generate predictive outcomes based on one or more training sets 222. The training set 222 can include, for example, historical data for a plurality of completed deliverables 212. The historical data can include, for example, historical tasks 214, resource data 213, and metadata associated with the plurality of completed deliverables 212. The resource data 213 can include, for example, historical performance metrics (e.g., cost, workload, quality, expected completion times, actual completion times, etc.) associated with one or more resources.

The model service 207 can generate a predicted completion date for each of a plurality of replacement resource candidates. The model service 207 can rank the plurality of replacement resource candidates according to the prediction completion date and/or additional metadata associated therewith, such as cost or workload. The model service 207 can identify an optimal replacement resource based on the ranking, for example, by determining a top-ranked replacement resource candidate (e.g., based on earliest predicted completion date, lowest cost, lowest workload, or combinations thereof). The model service 207 can compare predictions 223 associated with the replacement resource candidates to predetermined thresholds and, thereby, determine most optimal or minimally satisfactory replacement resource candidates. Non-limiting examples of the predetermined thresholds include completion date thresholds (e.g., a number of days within a particular completion date), a completion date change threshold, a cost change threshold, and a workload change threshold.

The model service 207 can improve performance of the model 217 via training and optimization. Training can include, but is not limited to, a) executing an initial iteration model 217 on a training set 222 to generate training predictions 223, b) comparing the training predictions 223 to known outcomes associated with the training set 222, c) determining an error or other underperformance of the initial iteration model 217 based on the comparison, and d) adjusting one or more properties 221 of the initial iteration model 217 towards reducing the error, thereby generating one or more secondary iteration models 217. The model service 107 can repeat the training process for any suitable number of repetitions to generate a secondary iteration model 217 that demonstrates performance above an acceptable performance threshold. In some embodiments, the acceptable performance threshold can be set by a user or computed based on various parameters. The model service 107 can compute a performance level of each of a set of completed tasks, deliverables and/or milestones, and calculate the performance threshold according to a statistical curve of that data. For example, the model service 107 may calculate the acceptable performance threshold as at or above the 25^{th} percentile of historical performance. The model service 107 can determine if the model 217 demonstrates performance above an acceptable performance threshold, for example, by comparing predictions 223 of the model 217 to known outcomes in the training set 222, generating one or more performance metrics based on the comparison, and comparing the one or more performance metrics to one or more predetermined thresholds. Non-limiting examples of performance metrics include prediction accuracy, prediction precision, logarithmic loss, confusion matrix, area under curve, F1 score, mean absolute error, and mean squared error.

The model 217 can include, for example, an artificial neural network having a set of layers, each having a set of parameters including a set of weights, a set of biases, and/or a set of activation functions. The model service 207 can train the model 217 to perform a set of arithmetic operations to correlate the historical program data 211 and resource data 213 to historical outcomes (e.g., completed deliverables 212) while attempting to optimize/improve a cost function. Following training, the model service 207 can execute the trained model 217 on input variables 219 (for example, current resource data 213 and tasks 214) to generate a prediction 223 for the completion of a current deliverable 212.

The model service 207 can evaluate the model 217 to determine the contribution of one or more input variables 219 to a corresponding prediction 223. The model service 207 can analyze the properties 221 to determine, for example, a weight value or other metric that was applied to each input variable 219, which may be indicative of the level of contribution of a corresponding input variable 219. In some embodiments, the model service 207 performs one or more sensitivity analyses to quantify the relationship between the size a set of input variables 219 and model performance. The model service 207 can optimize the input variables 219 or the model 217 based on the sensitivity analysis, for example, by adding or removing input variables 219, by assigning a fixed monotonic relationship between and input variable 219 and a prediction 223, or by adjusting other suitable properties 221 of the model 217.

In an exemplary scenario, the model service 207 executes a model 217 on a plurality of input variables 219 to generate a completion date prediction for a “break ground” deliverable. The input variables 219 include tasks 214 for “map utilities,” “conduct survey,” “review building codes,” “test soil,” and “conduct PR.” The model service 207 ranks each of the plurality of variables 219 based on a weight value that was applied by the model 217 to the corresponding variable to generate the completion date prediction. The model service 207 determines that the “map utilities” and “test soil” tasks demonstrate the highest positive weight value, thereby indicating that those tasks may be most critical towards achieving the completion date prediction. The model service 207 determines that the “conduct PR” task demonstrates the lowest positive weight value or the greatest negative weight value, thereby indicating that the task may be least critical for achieving the completion date prediction.

The computing device 203 can include any network-capable electronic device, such as, for example, personal computers, smartphones, and tablets. The computing device 203 can transmit, to the prediction system 201, program data 211, resource data 213, or data from which program data 211 or resource data 213 may be extracted or generated.

The computing device 203 can include, but is not limited to, one or more displays 225, one or more inputs devices 227, and an application 229. The display 225 can include, for example, one or more devices such as liquid crystal display (LCD) displays, gas plasma-based flat panel displays, organic light-emitting diode (OLED) displays, electrophoretic ink (E ink) displays, LCD projectors, or other types of display devices, etc. The input device 227 can include one or more buttons, touch screens including three-dimensional or pressure-based touch screens, camera, finger print scanners, accelerometer, retinal scanner, gyroscope, magnetometer, or other input devices. The application 229 can support and/or execute processes described herein, such as, for example, the prediction processes 300 and 500 shown in FIGS. 3 and 5, respectively, and described herein. The application 229 can generate user interfaces and cause the computing device 203 to render user interfaces on the display 225. For example, the application 229 generates a user interface including a recommendation 215.

The application 229 can generate and transmit requests to the prediction system 201. The application 229 can request and receive, from the prediction system 201, predictions 223 and various communications related to the same, such as, for example, recommendations based on one or more predictions 223. In one example, the application 229 can transmit, to the data service 205, a request for a predicted completion date of a particular deliverable 212 (e.g., the request including an expected completion date for the particular deliverable 212). The application 229 can receive, from the communication service 208, the predicted completion date for the particular deliverable 212 and a recommendation for a modification of one or more resources for completing the particular deliverable 212 by the predicted completion date. The application 229 can store requests and request responses in memory of the computing device 203 and/or at a remote computing environment configured to communicate with the computing device 203.

The external system 204 can include any public or private, network-capable computing environment (e.g., including virtual, cloud-based systems and physical computing systems). The external system 204 can store and transmit current and historical program data 211 and/or resource data 213 (e.g., or electronic records and other data from which program data 211 or resource data 213 may be derived). Non-limiting examples of external systems 204 include vendor and supplier systems (e.g., online stores, resource request portals, inventory systems, delivery scheduling and estimate systems, etc.), weather forecasting platforms and databases, public and private systems and databases related to construction project and other development data records, and communication systems and platforms (e.g., electronic mail servers, messaging platforms, social media sites, etc.). In one example, the data service 205 receives, from a vendor system, a set of costs and estimated delivery dates for a plurality of construction resources. In another example, the data service 205 receives, from a labor organization platform, a set of workload capacities and estimated labor expenses for hiring one or more laborers. In another example, the data service 205 receives, from a traffic information portal, road closures and detours associated with a particular project location. In another example, the data service 205 receives, from a weather forecasting service, estimated wind speeds, precipitation, and temperature for a particular project location and over a particular time interval (e.g., 1 week, 14 days, 1 month, 3 months, or any suitable interval).

FIG. 3 shows an exemplary prediction process 300 that can be performed by one or more prediction systems described herein, such as the prediction system 201 (see FIG. 2). The prediction system 201 can perform the prediction process 300 to predict a completion date for a deliverable 212, task 214, or milestone 216, and to determine the impact of one or more resources on the completion date. As will be understood by one having ordinary skill in the art, the steps and processes shown in FIG. 3 (and those of all other flowcharts and sequence diagrams shown and described herein) may operate concurrently and continuously, are generally asynchronous and independent, and are not necessarily performed in the order shown.

At step 303, the process 300 includes obtaining a training set 222 including historical data (e.g., historical program data 211 and/or resource data 213) for a plurality of completed deliverables 212. The data service 205 and NLP service 206 can retrieve and/or generate the historical program data 211 and resource data 213 from the data store 209, one or more computing devices 203, or one or more external systems 204. The model service 207 can generate the training set 222 based on the retrieved and/or generated data, and can store the training set 222 at the data store 209. The historical data can include, but is not limited to, historical resource costs, predicted and actual resource delivery dates, resource request lead times, predicted and actual deliverable completion dates, deliverable-associated electronic records, historical workloads, historical productivity and other performance metrics related to completing the completed deliverables 212. The completed deliverables 212 may be associated with a particular program (e.g., commercial building, single home construction, school construction, park construction, etc.) and program metadata (e.g., program location, weather, regulations, budgets, costs, etc.). The training set 222 can be a plurality of training sets 222, including segments of training sets 222 for testing and validation.

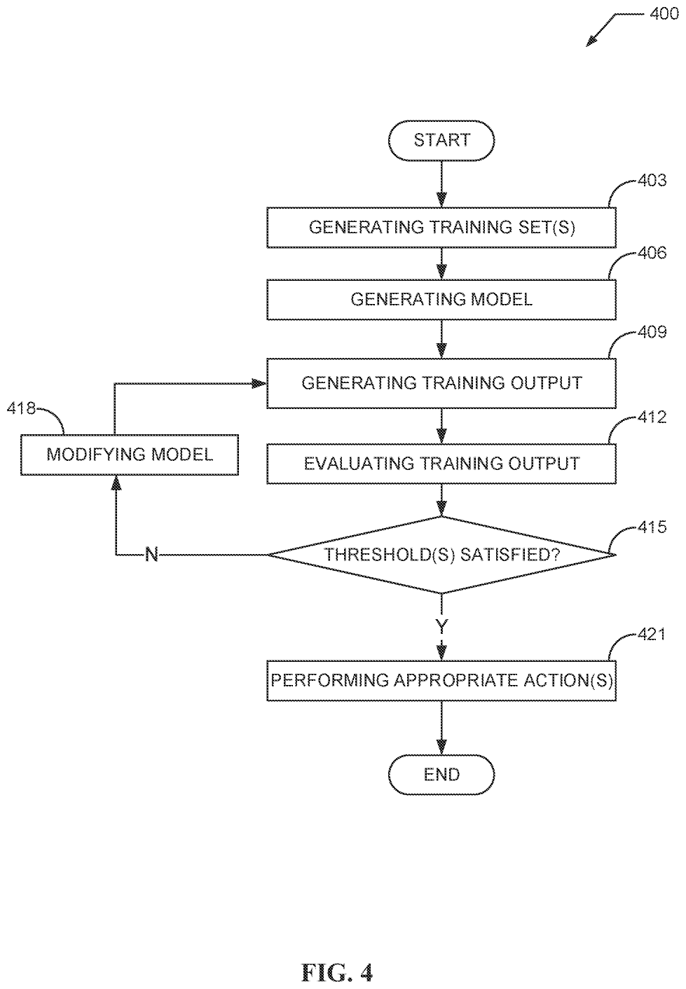

The process 300 can include performing one or more training processes 400 (e.g., shown in FIG. 4 and described herein) to generate and train a model 217 to generate predictions 223 based on the training set 222. By the process 400, the model service 207 can train a model 217 to determine a predicted completion date for one or more deliverables 212 by processing, via the model 217, metadata associated with the deliverable 212 and performance data corresponding to resource data 213 with which the deliverable 212 is associated. The process 300 can include applying the trained model 217 to program data 211, resource data 213, and/or metadata (e.g., in the form of variables 219) to generate various predictions 223.

At step 306, the process 300 includes determining a plurality of input variables 219 associated with the trained model 217. The model service 207 can determine the input variables 219 by determining historical program data 211, resource data 213, and/or metadata that most contributed to the predictions 223 generated during the training process 400. In some embodiments, the model service 207 includes predetermined input variables for a plurality of deliverables 212, and the model service 207 determines a subset of input variables 219 associated with the particular deliverable 212 for which prediction services are requested. In some embodiments, determination of one or more variables 219 occurs following step 309, at which the prediction system 201 identifies a deliverable 212 for which prediction services are requested.

At step 309, the process 300 includes receiving a prediction request (e.g., which may occur automatically) and identifying a deliverable 212 for which prediction services are requested. The request can identify a particular program and/or a particular deliverable 212 associated with the program. The data service 205 can determine the deliverable 212 based on the particular program and a plurality of historical deliverables 212 associated therewith. The communication service 208 can prompt a user to provide a selection or other input identifying the deliverable 212 or confirming the deliverable 212 has been correctly identified. Identifying the deliverable 212 can include determining metadata and performance data associated with the deliverable 212. The data service 205 and/or NLP service 206 can generate metadata and performance data for the deliverable 212 including, but not limited to, deliverable location, deliverable-associated tasks, task deadlines and durations, current workload metrics, and historical performance metrics (e.g., expected completion times and actual completion times for past completed deliverables similar or identical to the deliverable 212).

The data service 205 can receive the prediction request from a computing device 203. The data service 205 can generate the request automatically or in response to receiving input from a user. The data service 205 can generate the request automatically in response to determining a current date is within a predetermined range of an expected completion date of a deliverable 212, task 214, or milestone 216. The data service 205 can receive, from a computing device 203 or an external system 204, an indication that a deliverable 212, task 214, or milestone 216 has been scheduled for completion or an indication that one or more factors related to a deliverable 212, task 214, or milestone 216 have changed (e.g., a change in weather, a change in resource cost, a change in the scope or timeline of a deliverable 212, task 214, or milestone 216, etc.). The data service 205, in response to the indication, can automatically generate one or more prediction requests for initiating the process 300.

The prediction request can define a particular program (e.g., or resource, deliverable, task, or milestone thereof) for which prediction services are requested. The prediction request can include, but is not limited to, a) a request for a predicted completion date of a deliverable 212, task 214, or milestone 216, b) a request for one or more resources that may be required to complete a deliverable 212, task 214, or milestone 216, c) a request for one or more replacement resources or other modifications to resources for completing a deliverable 212, task 214, or milestone 216, and d) a request for the most influential factors for completing, or for delaying the completion of, a deliverable 212, task 214, or milestone 216.

The prediction request can include an expected completion date for a deliverable 212, task 214, or milestone 216. The prediction request can include one or more resources that are expected to be consumed or utilized for completing a deliverable 212, task 214, or milestone 216. The prediction request can include program data 211 and/or resource data 213 related to a deliverable 212, task 214, or milestone 216 for which prediction services are requested. The prediction request can include, for example, an expected cost for obtaining a resource, an expected delivery date for the resource, a required quantity of the resource, and/or a budgetary range for obtaining the resource. The prediction request can include one or more replacement candidate resources (e.g., resources that may or may not be used to replace other program resources). The prediction request can include a desired format of a recommendation 215, such as email, online report, text message, etc.

At step 312, the process 300 includes determining a subset of resource data 213 associated with completing the deliverable 212. The data service 205 can determine the resource data 213 from resource information in the prediction request of step 303. The data service 205 can retrieve particular resource data 213 from the data store 209 (e.g., the particular resource data 213 being assigned to, or otherwise associated in metadata, with the deliverable 212, task 214, or milestone 216 for which a prediction 223 will be generated). The data service 205 can determine one or more resources that may be used to complete the deliverable 212 (e.g., or that were used to complete past iterations of the deliverable 212). The data service 205 can determine performance data associated with the resource including, but not limited to, current workload, expected completion times, and actual completion times for past deliverables 212, tasks 214, or milestones 216 associated with the resource. The data service 205 can determine resource metadata including, but not limited to, cost associated with the resource, expected delivery of the resource, performance data, and metrics for estimating the volatility of resource cost and delivery. The performance data can include, but is not limited to, current workload, historical performance (e.g., expected completion times and actual completion times for past deliverables using the resource, expected and actual delivery times for the resource), and quantitative or qualitative ratings of the resource.

The data service 205 can determine the resource data 213 based on one or more tasks 214 associated with completing the deliverable 212. The data service 205 can determine the tasks 214 from the prediction request of step 303 and/or from historical tasks 214 and historical deliverables 212. The NLP service 206 can determine additional tasks 214 that may be associated with the deliverable 212 by applying a natural language model to a plurality of tasks 214 that are unrelated to the deliverable 212. The natural language model can generate a plurality of vectors individually corresponding to ones of the plurality of tasks 214. The NLP service 206 can generate a cluster or vector for the deliverable 212 by applying the natural language model to program data 211 and/or resource data 213 associated with the deliverable 212 (e.g., or similar historical deliverables 212). The NLP service 206 can determine a similarity score (e.g., distance) between each of the plurality of task vectors and the deliverable cluster. The NLP service 206 can determine one or more of the plurality of tasks 214 for use as an input variable 219 based the corresponding similarity score meeting a predefined threshold.

In some embodiments, the model service 207 uses the subset of resource data 213 as input variables 219 to the trained model 217.

At step 315, the process 300 includes generating a completion date prediction 223 for completing the deliverable 212 (e.g., using resources associated with the subset of resource data 213 determined at step 312). In some embodiments, the model service 207 generates a plurality of input variables 219 based on the metadata and performance data associated with the deliverable 212 (e.g., and, in some embodiments, based on the subset of resource data 213 identified at step 312). The model service 207 can generate the completion date prediction 223 by processing the metadata associated with the deliverable 212 and performance data corresponding to the subset of resource data 213 assigned to the deliverable (e.g., as determined at step 312).

At step 318, the process 300 includes comparing the completion date prediction 223 to an expected completion date for the deliverable 212. The model service 207 can perform the comparison and determine a completion date delta based thereon (e.g., a measure of difference between predicted and expected completion dates). For example, at step 315, the model 217 generates a predicted completion date of May 29, 2023 for a “break ground” deliverable. The model service 207 compares the predicted completion date to an expected completion date of May 19, 2023 and determines a delta of 10 days.

At step 321, the process 300 includes generating, based on the comparison of step 318, a recommendation 215 for modifying one or more resources associated with the subset of resource data 213 that was identified at step 312. The model service 207 can determine one or more modifications to the subset of resource data 213 that, when present, reduce the delta between the completion date prediction 223 and the expected completion date of the deliverable 212. The model service 207 can determine one or more input variables 219 and resource data 213 associated therewith that most heavily contributed to the completion date prediction 223. The model service 207 can determine a modification to the resource data 213 such that a new completion date prediction 223 may be shifted closer to the expected completion date. The modification to the resource data 213 can include, but is not limited to, replacing a resource with a another resource (referred to as a “replacement resource”), ordering delivery of the resource at an earlier date and/or from a different vendor, increasing an amount of labor available to utilize the resource, and adjusting a schedule for utilizing the resource (e.g., performing resource-consuming tasks 214 in a different order, performing tasks 214 concurrently, etc.).

The model service 207 can determine a resource modification for one or more resources in the subset of resource data 213 associated with completing the deliverable 212. The model service 207 can determine a modified completion date prediction 223 for the deliverable 212 using a modified version of the resource (e.g., which may include substituting the resource with a replacement resource). The model service 207 can compare the previous completion date prediction 223, the modified completion date prediction 223, and the expected completion date to determine if the resource modification is predicted to reduce the delta of predicted versus expected completion date (e.g., absolute reduction or a level of reduction that meets a predetermined threshold, such as 1 day delta, 3 day delta, or any suitable value). In response to a determination, the resource modification may improve the completion date prediction, the communication service 208 can generate a recommendation 215 including the resource modification. The model service 207 can identify multiple resource modifications, as will be appreciated. The model service 207 can evaluate a plurality of candidate resource modifications to generate a plurality of delta impacts. The model service 207 can rank the candidate resource modifications by most positive delta impact (e.g., the greatest reduction in delta) and can determine one or more top-ranked entries of the ranking as recommended resource modifications. The data service 205 can determine one or more costs associated with each resource (e.g., cost of delivery, cost of use, cost of labor, cost of storage, total cost, etc.). The communication service 208 (e.g., and/or the model service 207) can determine the resource recommendation 215 based on determining a least costly or most cost-efficient resource modification.

The recommendation 215 can include a recommendation to extend the expected completion date of the deliverable 212 to the completion date prediction 223 (e.g., or a date therebetween). The model service 207 (e.g., and/or data service 205) can determine that a costs of resources for completing the deliverable 212 by the expected completion date exceeds a predetermined threshold (e.g., a predetermined budget, a predetermined amount or percentage in excess of the budget, etc.). In response to the determination, the communication service 208 can generate the recommendation 215 including the completion date prediction 223, the resource(s) predicted to exceed the cost threshold, and guidance for extending the expected completion date of the deliverable 212 to the completion date prediction 223. The recommendation 215 can include dependencies associated with the deliverable 212 that may also require adjustment (e.g., if the deliverable 212, or resources used for completing the same, are modified). The program data 211 and resource data 213 can include indications of dependency between deliverables 212, tasks 214, milestones 216, and resources. Based on a recommended modification to a deliverable 212 completion date and/or resources, the data service 205 can identify dependencies for adjustment in kind, such as, for example, materials, human resources and labor, permits, inspections, loans and other funding and financing activities, and public relations activities.

At step 324, the process 300 includes performing one or more appropriate actions. Non-limiting examples of appropriate actions include transmitting the recommendation 215 to a computing device 203, generating a user interface and causing the computing device 203 to render the user interface, prompting a computing device 203 to approve a recommended resource modification, and tuning the model 217 based on actual completion data received following completion of the deliverable 212. The communication service 208 can generate a user interface including the recommendation 215 (e.g., including a recommended resource modification) and, in some embodiments, the comparison of the completion date prediction 223 to the expected completion date of the deliverable 212. The communication service 208 or application 229 can cause the computing device 203 to render the user interface. The communication service 208 can transmit the recommendation 215 to the application 229 for rendering on the computing device 203.

The data service 205 can receive additional program data 211 and/or resource data 213 associated with completion of the deliverable 212. For example, the data service 205 can receive an actual completion date of the deliverable 212 and performance data associated with resources used to complete the deliverable 212 (e.g., costs, requisite workloads, qualitative or quantitative ratings, etc.). The model service 207 can generate training sets 222 based on the additional program data 211 and resource data 213. The model service 207 can further train the model 217 on the additional training sets 222, potentially improving the predictive performance thereof.

The model service 207 can compare an actual completion date of a deliverable 212 to a completion date prediction 223 for the same deliverable 212. The model service 207 can determine an error of the completion date prediction 223 based on the comparison. The model service 207 can audit the model 217 that generated the completion date prediction 223 and can determine one or more input variables 219 and/or properties 221 that may have contributed to the error. The model service 207 can adjust the input variables 219 and/or properties 221 of the model 217 toward reducing the error and can retrain the model 217 via one or more training processes 400 (FIG. 4) to confirm improvement of model performance and reduction of the error.

FIG. 4 shows a training process 400. The model service 207 can perform the training process 400 to train a model 217 to generate predictions 223, such as, for example, predicted completion date of a deliverable 212, task 214, or milestone 216, predicted delay to completing a deliverable 212, task 214, or milestone 216, and predicted cost(s) of a delay to completing a deliverable 212, task 214, or milestone 216.

At step 403, the process 400 includes generating one or more training sets 222. The model service 207 can generate a training set 222 including historical program data 211 and historical resource data 213 associated with completed deliverables 212, tasks 214, or milestones 216. The model service 207 can determine relevant historical program data 211 and historical resource data 213 for inclusion based on identifying historical deliverables 212 that are similar or identical to a current deliverable 212. The NLP service 206 can apply natural language models to historical program data 211 and historical resource data 213 to identify entries therein that may be relevant to the current deliverable 212 (e.g., but may lack discrete association therewith). The training set 222 can include known outcomes of the historical deliverables 212, such as, for example, actual and expected completion dates, actual resources utilized (e.g., and metadata associated therewith, such as, costs, requisite workloads, predicted and actual completion dates, etc.). The model service 207 can generate, and include in the training set 222, variables 219 based on the historical program data 211 and historical resource data 213.

At step 406, the process 400 includes generating a model 217 for generating one or more predictions 223 described herein (e.g., an initial iteration model 217 or a secondary iteration model 217 following modification of the model 217 at step 418). The model service 207 can generate a machine-learning model configured to predict a completion date for a deliverable 212 by processing input variables 219 including program metadata associated with a deliverable 212 and performance data corresponding to a subset of resource data 213 assigned to the deliverable 212. The model service 207 can generate a machine-learning model configured to predict a delay to a completion date for a deliverable 212.

At step 409, the process 400 includes generating training output by processing the training set 222 via the model 217. The training output can include, for example, a predicted completion date for a deliverable 212, a predicted delay to an expected completion date, and a predicted cost of a delay to an expected completion date.

At step 412, the process 400 includes evaluating the training output of step 409. The model service 207 can evaluate the training output by comparing the training output to the known outcomes of the training set 222 and determining one or more error or other performance metrics of the model 217 based on the comparison. Non-limiting examples of error metrics include percent accuracy, percent deviation, R², mean squared error, and root mean squared error.

At step 415, the process 400 includes determining if the model 217 meets one or more error or other performance thresholds. The model service 207 can compare the error metric to the threshold. In response to the error metric meeting the error threshold, the process 400 can proceed to step 421. In response to the error metric failing to meet the error threshold, the process 400 can proceed to step 418 and can repeat steps 409-418 until generating an iteration of the model 217 that meets the error threshold.

At step 418, the process 400 includes adjusting one or more properties 221 of the model 217 toward reducing the error or otherwise improving the performance thereof. The model service 207 can adjust properties 221, such as, for example, coefficients and weight values applied to input variables 219, learning rate, maximum depth, choice of activation function, and choice of optimization algorithm or gradient boosting technique. The model service 207 can generate a second iteration model 217 encompassing the adjusted properties 221.

At step 421, the process 400 includes performing one or more appropriate actions including, but not limited to, storing the trained model 217, generating actual predictions 223 via the trained model 217, and generating a summary of the performance of the trained model 217. The summary can include, for example, a deliverable for which the trained model 217 was trained to generate predictions 223, indications of the training set 222 used to perform training, and one or more error or other performance metrics of the trained model 217.

FIG. 5 shows an exemplary prediction process 500. The prediction system 201 can perform the process 500 to generate a prediction 223 for a cost of completing a deliverable 212, task 214, or milestone 216 by a particular completion date and using a particular set of resource data 213. The process 500 can leverage predictions 223 from other predictive processes, such as the prediction process 300 shown in FIG. 3 and described herein. For example, via the process 300, the prediction system 201 can generate a completion date prediction 223A for a deliverable 212, the completion prediction date 223 being associated with a set of resource data 213 that includes a recommended modification to at least one resource. The prediction system 201 can perform the process 500 to predict a cost of completing the deliverable 212 using the set of resource data 213. The prediction system 201 can perform the process 500 to predict a minimum completion date for the deliverable 212 at a maximum allowable cost for the set of resource data 213.

At step 501, the process 500 includes generating a training set 222 including historical program data 211 and historical resource data 213 associated with completing a particular deliverable 212. The training set 222 includes historical costs associated with completing the particular deliverable 212 (e.g., or similar historical deliverables 212). The model service 207 can filter the training set 222 based on a completion date prediction 223A for the particular deliverable 212. For example, the model service 207 determines a timeframe corresponding to a current date and the completion date prediction 223A and corresponding to a location associated with the particular deliverable 212. Based thereon, the model service 207 filters the training set 222 to include only data that is associated with completing a historical deliverable 212 within a similar timeframe and at the same or a similar location as the particular deliverable.

The process 500 can include performing a training process 400 to generate and train a model 217 that predicts a cost of completing a deliverable within a particular timeframe, at a particular location, and using a particular set of resources.

At step 503, the process 500 includes generating a cost prediction 223B for completing the particular deliverable 212 by the completion date prediction 223A and using a particular set of resources (e.g., a set of resources assigned to the particular deliverable 212 and, in some embodiments, including a recommended modification to one or more resources). The trained model 217 can process the completion date prediction 223A and the particular set of resources to generate the cost prediction 223B. The model service 207 can determine one or more most-costly resources based on the cost prediction 223B.

At step 506, the process 500 includes determining if the cost prediction 223B meets a cost threshold, such as, for example, a maximum cost threshold. The model service 207 can compare the cost prediction 223B to the cost threshold. In response to the cost prediction 223B meeting the threshold, the process 500 can proceed to step 512. In response to the cost prediction failing to meet the threshold, the process 500 can proceed to step 509.

At step 509, the process 500 includes replacing one or more resources of the particular set of resources. The data service 205 can determine replacement resources for the one or more most-costly resources determined at step 503. The replacement resource can refer to a different material or labor source. The replacement resource can refer to the same resource provided by a different vendor and/or delivered on a different timetable (e.g., standard shipping vs. express shipping, rail delivery vs. truck delivery, etc.).

After determining the replacement resource, the model service 207 can perform the training process 400 and steps 501-506 to generate a new cost prediction 223B using the replacement resource and determine if the new cost prediction meets the predetermined threshold. The process 500 can include iteratively repeating the training process 400 and steps 501-509 until a set of resources are determined to correspond to a cost prediction 223B that satisfies the cost threshold. The process 500 can include determining that no combination of resources exists for which the predicted cost meets the cost threshold. In response to such a determination, the process 500 can proceed to step 512.

At step 512, the process 500 includes performing one or more appropriate actions. The communication service 208 can generate and transmit a recommendation 215 to the computing device 203 (e.g., or generate a user interface including the recommendation 215 and cause the computing device 203 to render the user interface). The recommendation 215 can the completion date prediction 223A and the cost prediction 223B associated with completing the deliverable 212 by the completion date prediction 223A.

In response to determining that no combination of resources exists for which the predicted cost meets the cost threshold, the communication service 208 may generate and transmit a recommendation 215 to a) extend the expected completion date of the deliverable 212 past the completion date prediction 223A orb) increase the cost threshold for completing the deliverable 212 within the completion date prediction 223A. The recommendation 215 can include one or more most-costly resources associated with the failure of the cost prediction 223B to meet the cost threshold. The model service 207 can determine a minimum extension to the completion date by iteratively performing the process 500 on the same set of resources using different timeframes (e.g., completion dates extending past the completion date prediction by 1 day, 2 days, 1 week, or any suitable interval). The recommendation 215 can include the minimum extension and the predicted completion date and cost prediction 223B associated therewith.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions. The computer-executable instructions can be stored on a non-transitory computer-readable medium.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a various embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a particular sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein.

What is claimed is:

1. A system, comprising:
a data store comprising a training data set comprising historical data for a plurality of completed deliverables; and
at least one computing device in communication with the data store, the at least one computing device configured to:
train at least one machine-learning model to generate predictive outcomes based on the training data set;
determine a plurality of input variables associated with the at least one machine-learning model;
identify a deliverable corresponding to a particular program, the deliverable comprising a plurality of tasks and metadata associated with the deliverable;
determine a subset of resources from a plurality of resources, wherein the subset of resources are assigned to the deliverable;
determine a predicted completion date for the deliverable by processing, via the at least one machine-learning model, the metadata associated with the deliverable and performance data corresponding to the subset of resources assigned to the deliverable;
perform a comparison of the predicted completion date of the deliverable to an expected completion date of the deliverable; and
generate a recommended modification to the subset of resources assigned to the deliverable based on the comparison.

2. The system of claim 1, wherein the at least one computing device configured to:
determine a selected resource for modification from the subset of resources;
determine an estimated completion date for the deliverable using the selected resource;
determine an actual completion date for the deliverable; and
tune the at least one machine-learning model based on the estimated completion date and the actual completion date.

3. The system of claim 1, wherein the at least one computing device configured to determine a plurality of costs individually associated with a corresponding one of the subset of resources, wherein the recommended modification is generated based in part on the plurality of costs.

4. The system of claim 1, wherein the performance data further comprises a plurality of respective data metrics for each of the subset of resources.

5. The system of claim 4, wherein the plurality of respective data metrics comprises a current workload metric and a historical performance metric.

6. The system of claim 5, wherein the historical performance metric comprises a plurality of expected completion times and a corresponding plurality of actual completion times for past deliverables.

7. The system of claim 1, wherein generating the recommended modification comprises the at least one computing device being further configured to:
identify at least one replacement resource from the plurality of resources;
generate a modified subset of resources by modifying the subset of resources based on the at least one replacement resource;
determine a modified predicted completion date based on the modified subset of resources via the at least one machine-learning model; and
generate the recommended modification to assign the modified subset of resources for the deliverable based on a second comparison of the modified predicted completion date to the predicted completion date.

8. The system of claim 1, wherein the at least one computing device is configured to:
generate a user interface comprising the recommended modification; and
cause a second computing device to render the user interface.

9. The system of claim 8, wherein the user interface further comprises the comparison of the predicted completion date of the deliverable to the expected completion date of the deliverable.

10. The system of claim 1, wherein the at least one machine-learning model comprises a multilayer neural network.

11. The system of claim 10, wherein training the at least one machine-learning model comprises adjusting at least one parameter of the multilayer neural network, wherein the at least one parameter comprises an activation function, one or more initial weight values, a number of hidden layers, or a number of activation units in at least one hidden layer of the multilayer neural network.

12. A method, comprising:
training, via at least one computing device, at least one machine-learning model to generate predictive outcomes based on a training data set comprising historical data for a plurality of completed deliverables;
determining, via the at least one computing device, a plurality of input variables associated with the at least one machine-learning model;
identifying, via the at least one computing device, a deliverable corresponding to a particular program, the deliverable comprising a plurality of tasks and metadata associated with the deliverable;
determining, via the at least one computing device, a subset of resources from a plurality of resources, wherein the subset of resources are assigned to the deliverable;
determining, via the at least one computing device, a predicted completion date for the deliverable by processing, via the at least one machine-learning model, the metadata associated with the deliverable and performance data corresponding to the subset of resources assigned to the deliverable;
performing, via the at least one computing device, a comparison of the predicted completion date of the deliverable to an expected completion date of the deliverable; and
generating, via the at least one computing device, a recommended modification to the subset of resources assigned to the deliverable based on the comparison.

13. The method of claim 12, further comprising:
applying, via the at least one computing device, a natural language model to a plurality of particular tasks unrelated to the deliverable to determine a plurality of vectors individually corresponding to one of the plurality of particular tasks; and
determining, via the at least one computing device, a subset of related tasks of the plurality of particular tasks based on a subset of the plurality of vectors meeting a predefined threshold.

14. The method of claim 12, wherein the historical data comprises a plurality of historical resources used to complete each of the plurality of completed deliverables.

15. The method of claim 14, wherein the historical data comprises a cost of each of the plurality of historical resources.

16. The method of claim 12, wherein the historical data comprises, for each of the plurality of completed deliverables, an actual completion date and at least one expected completion date.

17. A non-transitory computer-readable medium embodying a program that, when executed by at least one computing device, causes the at least one computing device to:
train at least one machine-learning model to generate predictive outcomes based on a training data set comprising historical data for a plurality of completed deliverables;
determine a plurality of input variables associated with the at least one machine-learning model;
identify a deliverable corresponding to a particular program, the deliverable comprising a plurality of tasks and metadata associated with the deliverable;
determine a subset of resources from a plurality of resources, wherein the subset of resources are assigned to the deliverable;
determine a predicted completion date for the deliverable by processing, via the at least one machine-learning model, the metadata associated with the deliverable and performance data corresponding to the subset of resources assigned to the deliverable;
perform a comparison of the predicted completion date of the deliverable to an expected completion date of the deliverable; and
generate a recommended modification to the subset of resources assigned to the deliverable based on the comparison.

18. The non-transitory computer-readable medium of claim 17, wherein the program, when executed by the at least one computing device, causes the at least one computing device to:
determine a first cost of completing the deliverable by the predicted completion date using the subset of resources;
generate a modified subset of resources based on the subset of resources and the recommended modification;
determine a second cost of completing deliverable by the predicted completion date using the modified subset of resources; and
adjust the recommended modification to the subset of resources based on a second comparison of the first cost to the second cost.

19. The non-transitory computer-readable medium of claim 17, wherein the program, when executed by the at least one computing device, causes the at least one computing device to:
determine that a current date is within a predetermined range of the expected completion date; and
in response, determine the predicted completion date for the deliverable.

20. The non-transitory computer-readable medium of claim 17, wherein the at least one machine-learning model is configured to determine the predicted completion date for the deliverable based on a maximum allowable cost associated with the subset of resources.
